(19) United States
(12) Patent Application Publication
(10) Pub. No.: US 2018/0352275 A1
(43) Pub. Date: Dec. 6, 2018

(54) System and Method for Recommendation of Content Based on Mood and Other External Factors

(71) Applicant: The DIRECTV Group, Inc., El Segundo, CA (US)

(72) Inventors: Dimitri Alexander, Los Angeles, CA (US); Leon Stewart, III, Hawthorne, CA (US); David Hughes, Venice, CA (US); Eric Toyofuku, Long Beach, CA (US)

(21) Appl. No.: 15/610,164

(22) Filed: May 31, 2017

(51) Int. Cl. H04N 21/25; H04L 29/08; H04N 21/466; H04N 21/258; H04N 21/45

(52) U.S. Cl. CPC H04N 21/251; H04L 67/306; H04N 21/4532; H04N 21/25891; H04N 21/4668

(57) ABSTRACT

A method includes receiving a request for a recommendation for content, wherein the request includes an indication of a user's mood, responsive to the receiving request, accessing a user profile, characterizing upcoming content by assigning at least one attribute to the content, generating the recommendation based on the user profile, the user's mood and the at least one attribute.

### TECHNICAL FIELD

Embodiments of the present inventions relate to methods and systems for recommending content to customers, and more particularly, to methods and systems including recommendations based on mood or other external events.

### BACKGROUND

Current recommendation algorithms may include several factors to be considered, including, for example, recent viewing history, viewer profiles, and others. Many times recommendations are curated based on generic factors of location, socio-economics, examples of like programming, and the like.

However, there is no service that recommends video content based the consideration of a viewer's current mood, which could vary by the day or even by the hour. Such a recommendation service may permit a user a new and easy way to discover relevant content based a set of user-specific data. There is a need to consider other aspects of user's behavior that affects mood and therefore programming recommendations, including, but not limited to, factors such as weather and activities that affect a viewer's emotions such as happy, sad, afraid, surprised, angry, or disgusted, to name a few.

### SUMMARY

The present disclosure is directed to method including receiving, by a server, a request for a recommendation for content, wherein said request includes an indication of a user's mood, responsive to the receiving request, the server retrieving a user profile, characterizing, by the server, upcoming content by assigning at least one attribute to the content, and generating, by the server, the recommendation based on the user profile, the user's mood and the at least one attribute. The method may further include receiving, by the server, an indication of activity associated with the request and wherein the recommendation is further based on the indication of activity and receiving, by the server, a preference of genre associated with the request and wherein the recommendation is further based on the preference of genre. In an aspect, the request applies to a first time period and the recommendation is based on content available during the first time period and in another aspect, the method may further include receiving a second request wherein the second request applies to a second time period and wherein the generating step comprises generating a first recommendation for the first time period and a second recommendation for the second time period wherein the first recommendation and the second recommendation is based at least in part on the request an indication of the user's mood for the first time period and the second time period. The server may be in communication with a user device associated with the profile of a user and wherein the request is received from the user device. In an aspect, the mood suggested may be based on an external event and may, for example, be suggested based on a personal electronic schedule of a user associated with the user profile retrieved by the server.

The disclosure is also directed to a server including an input/output system for communicatively coupling the server to a user device a storage source, a processor communicatively coupled to the input/output system, memory storing instructions that cause the processor to effectuate operations, the operations including receiving, by the server, a request for a recommendation for content, wherein said request includes an indication of a user's mood, responsive to the receiving request, the server retrieving a user profile, characterizing, by the server, upcoming content by assigning at least one attribute to the content, and generating, by the server, the recommendation based on the user profile, the user's mood and the at least one attribute. The operations may further include receiving, by the server, an indication of activity associated with the request and wherein the recommendation is further based on the indication of activity and receiving, by the server, a preference of genre associated with the request and wherein the recommendation is further based on the preference of genre. In an aspect, the request applies to a first time period and the recommendation is based on content available during the first time period.

In an aspect, the operations may further include receiving a second request wherein the second request applies to a second time period and wherein the generating step includes generating a first recommendation for the first time period and a second recommendation for the second time period wherein the first recommendation and the second recommendation is based at least in part on the request an indication of the user's mood for the first time period and the second time period. The operations may further include suggesting a mood based on a personal electronic schedule of a user associated with the user profile.

In accordance with disclosure, there is also a system including a set top box communicatively coupled to a user device and to a server, the set top box also in communication with an audio-video display and wherein the set top box is configured to receive inputs from the user device and wherein the inputs include an indication of a user's mood, a server communicatively coupled to set top box, the server having a processor and a memory storing instructions that cause the processor to effectuate operations, the operations including receiving, by the server, a request from the set top box for a recommendation for content, wherein said request includes the indication of the user's mood, responsive to the receiving request, the server retrieving a user profile, characterizing, by the server, upcoming content by assigning at least one attribute to the content, generating, by the server, the recommendation based on the user profile, the user's mood and the at least one attribute, and receiving, by the server, a selection based on the recommendation. The operations may further include streaming content associated with the selection to the set top box for viewing on the audio-video display.

### BRIEF DESCRIPTION OF THE DRAWINGS

The following detailed description of preferred embodiments is better understood when read in conjunction with the appended drawings. For the purposes of illustration, there is shown in the drawings exemplary embodiments; however, the subject matter is not limited to the specific elements and instrumentalities disclosed. In the drawings:

FIG. 1 is a schematic representation of an exemplary system environment in which the methods and systems to generate recommendations may be implemented;

FIG. 2 is a functional block diagram of an exemplary server shown in FIG. 1;

FIG. 3 is an exemplary functional block diagram of a mood/activity matrix;

FIG. 4 is an exemplary user preference data block; and

FIG. 5 is process flow of a method of operation in accordance with the present disclosure.

### DETAILED DESCRIPTION OF ILLUSTRATIVE EMBODIMENTS

Overview. The present disclosure is directed to a recommendation service for movies, shows and other content. The service may be resident on a set top box (STB) or on a server and accessible via a STB or a smartphone or other handheld device. The system and method provides to a user recommendations based on a user's profile and additional information which may, for example, include time of day, day of week, date, month, quarter or year, the user's mood which may, for example, include happy, sad, afraid, surprised, angry or disgusted, and or activities such as, for example, background noise or setting, family night, couch potato, and the like.

System Environment.

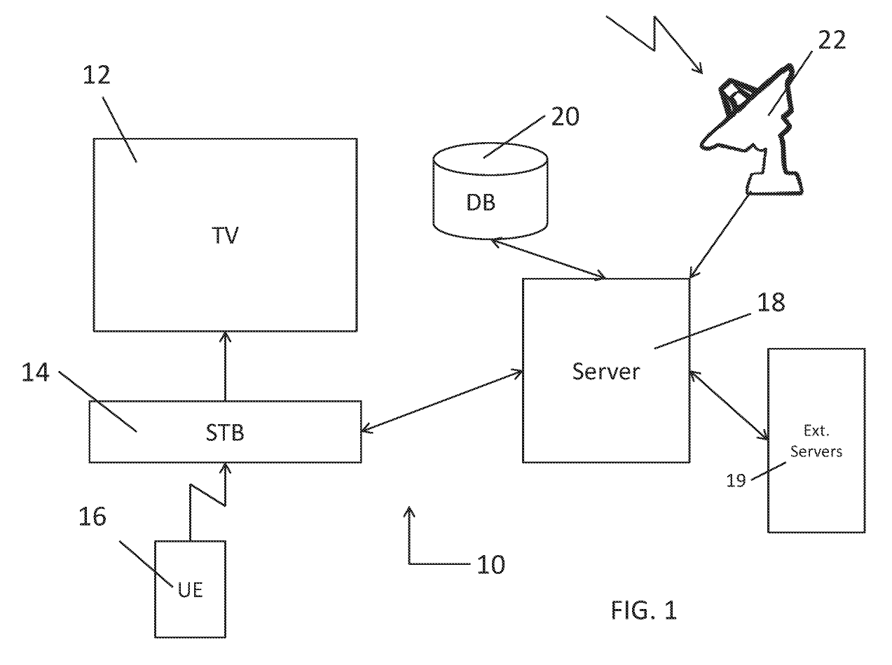

Illustrated in FIG. 1 is a schematic representation of an exemplary system 10 environment in which embodiments of the present disclosure may operate. In the exemplary system 10, there is shown a television 12 as a video output of an entertainment system 10. While the television 12 is shown in an exemplary system, those skilled in the art will understand that the television 12 may be any type of video output, including but not limited to, video outputs associated with a tablet, smartphone, personal computer, LCD, or any other video output display. The television screen 12 is in communication with a set-top box (“STB”) 14 which may be controlled by user equipment (“UE”) 16 and which STB 14 may be in communication with server 18. It will be understood that STB 14 may contain a variety of functions controlled by and accessed by UE 16. Alternatively, the present disclosure does not require a STB 14 in order for system 10 to be operational and the UE 16 may be in direct communication with both television 12 and server 18.

The UE 16 may, for example, be a traditional remote control for a STB 14 having a proprietary operating system and application and physical interfaces particular to a manufacturer or service provider. Alternatively, UE 16 may be a smartphone, tablet or personal computer configured with an operating system which may, for example, be one of Apple's iOS, Google's Android, Microsoft Windows Mobile, or any other smartphone operating system or computer operating system or versions thereof. The UE 16 may control user input functions, including, but not limited to, selection and control of channel, movies, recordings, applications and other functions. The UE 16 may provide the ability for a user to input preference data, billing information, profile information, friends, likes and dislikes, or other inputs that enable or personalize the functions available to a user.

The UE 16 may have a communication interface for a wireless or wired communication system. In the exemplary configuration of FIG. 1, there is shown a wireless interface to a set-top box 14. The UE 16 and/or STB 14 may also have other communication interfaces, including but not limited to cellular communication system including 3G, 46 LTE, and 5G, WiFi, LAN, WiLan or any other communication system compatible with the UE 16 and/or STB 14.

The UE 16 may be in communication with an application server 18. The functionality included in the disclosure may reside either or the UE 16 or the application server 18 or a combination thereof. Such designation of functionality between the UE 16 and application server 18 may be a design choice or based on user experience, performance, cost, or any other factor. The allocation of functionality between UE 16 and application server 18 is exemplary only and non-limiting in scope of the present disclosure.

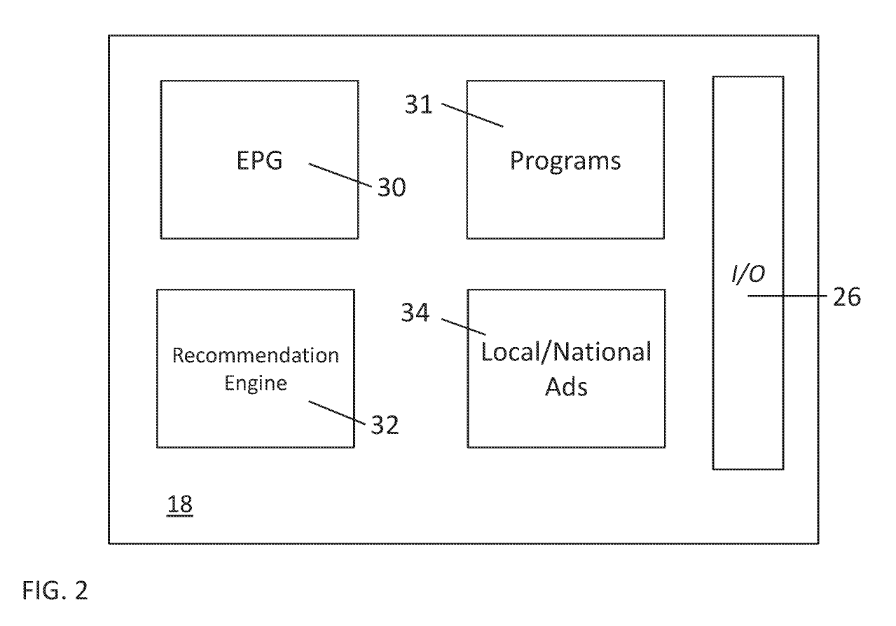

With reference to FIG. 2, there is shown an exemplary functional block diagram of a server 18. The server 18 may include an input/output port 26 for communication with other devices including the STB 14. The server 18 may also include an electronic program guide (EPG) 30. The EPG 30 may include upcoming program listings, which may, for example include sports programming scheduled in the next two weeks. The server 18 may also include storage of programs 31, either temporarily or permanent, which may be provided to viewers to watch. The recommendation engine 32 provides the recommendations based on user inputs and a database containing upcoming content with attributes associated with the content. Local ads and national ads 34 may also be included and stored in server 18. It will be understood that the configuration of server 18 is exemplary only and any or all of the functions may be distributed among multiple servers or computer networks or the STB and/or UE 16.

Functional Description.

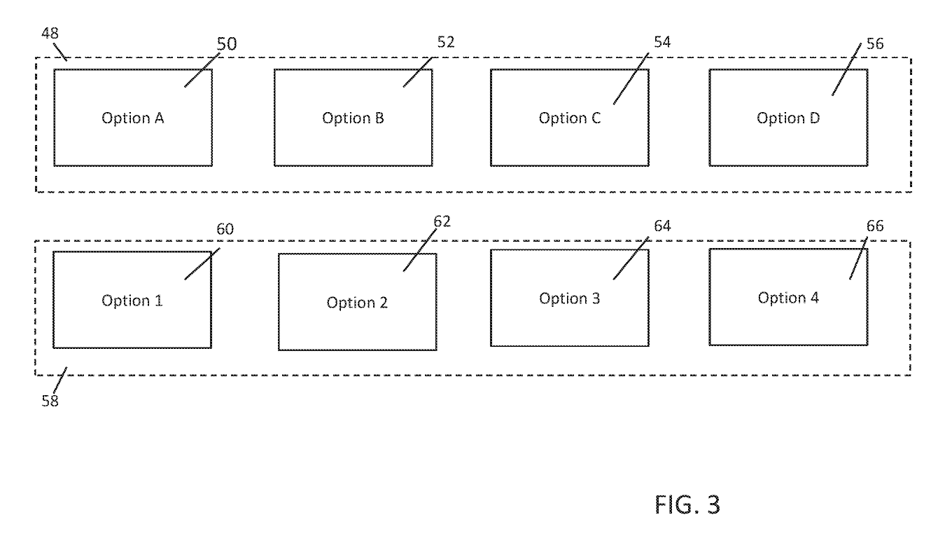

Illustrated in FIG. 3 is a generic matrix showing a first set of options on a top bar 48 and a second set of options on the bottom bar 58. This is exemplary only and other configurations, including additional option bars, may be included and fall within the scope of the present disclosure. In an aspect, the top bar 48 may include moods, wherein Option A 50 may be happy, Option B 52 may be sad, Option C 54 may be afraid and Option D 56 may be contemplative. It will be understood that additional options may be included in the top bar 48 and may include, in this example, other mood descriptors. Such mood descriptors may be entered by a user through UE 16 when requesting recommendations for content.

In an aspect, the bottom bar 58 may include a second set of options relating to expected activity. For example, Option A 60 may be “family night”, Option B 62 may be “background noise”, Option C 64 may be “couch potato mode” and Option D 66 may be “hang out with friends”. It will be understood that additional options may be included in the bottom bar 58 and may include, in this example, other activities. Such activities may be entered by a user through UE 16 when requesting recommendations for content.

By way of example, a user may select Option A 50 on top bar 48 and Option C 64 on bottom bar 58 such that the user enters the equivalent of “I'm in the mood to be happy while I am in couch potato mode”. Another example may be Option C 54 on top bar 48 and Option D 66 on bottom bar 58 such that the user enters the equivalent of “I'm in the mood to be frightened while I hang out with friends”. Other examples will be evident to those skilled in the art.

It is possible to extend the matrix to additional bars representing additional factors to be used in the recommendation process. For example, the user may, through the UE 16, enter a genre. Thus, for example, a user who is in a happy mood may select “comedy” as a genre. A user who is in investigative mood may select “mystery” as a genre. It will be understood that these are exemplary only and that other genres may be selected depending on the mood.

In addition to user inputs, the system 10 may import data from external sources other than the user. For example, the system 10 may use extrinsic data such as time factors, including, for example, time of day, day of week, month, season, year or any combination thereof as an input to be considered along with the user inputs. Additionally, the system 10 may capture other extrinsic data such as personal electronic calendars, weather, current events, historical anniversaries, for example, D-Day, or any other extrinsic data as a factor. Such factors may be retrieved from one or more external servers, represented as server 19 in FIG. 1.

In an aspect, the external sources may suggest a mood to be selected by the user. For example, if a user's personal electronic calendar indicates a study session has just ended, the suggested mood may be “light” to relieve the stress of the recently suggested study session. The suggestion may be automatically input or may be a highlighted option that still needs to be selected by the user.

With respect to upcoming programming content, in an aspect, a program may have certain attributes associated with the program, which may, for example, include but not be limited to genre, mood, and activities. For example, a program may have attributes to coincide with one or more general moods. For example, a Disney® comedy animated movie may have mood attributes of “funny,” “silly,” and/or “cartoonish” associated therewith, genre attributes such as “animation,” “children's programming” and/or “comedy”, and activity attributes such as “social setting” and/or “children's party.” Another example may be a West Virginia documentary which may have mood attributes of “adventurous” and/or “inquisitive” associated therewith, genre attributes including “documentary,” and/or “nature,” and activity attributes such as “studying,” and/or “discussion groups.” Other attributes associated with content may include historical significant events, such as the anniversary of an historical event such as D-Day or a holiday such as the birthday of Martin Luther King, Jr. or Independence Day. A curator may decide that certain programming is more popular based on time and weather, such that a program may have attributes that include “rainy day” and “Saturday afternoon.” Each upcoming program may have one or more of such intrinsic and/or external attributes associated with the program.

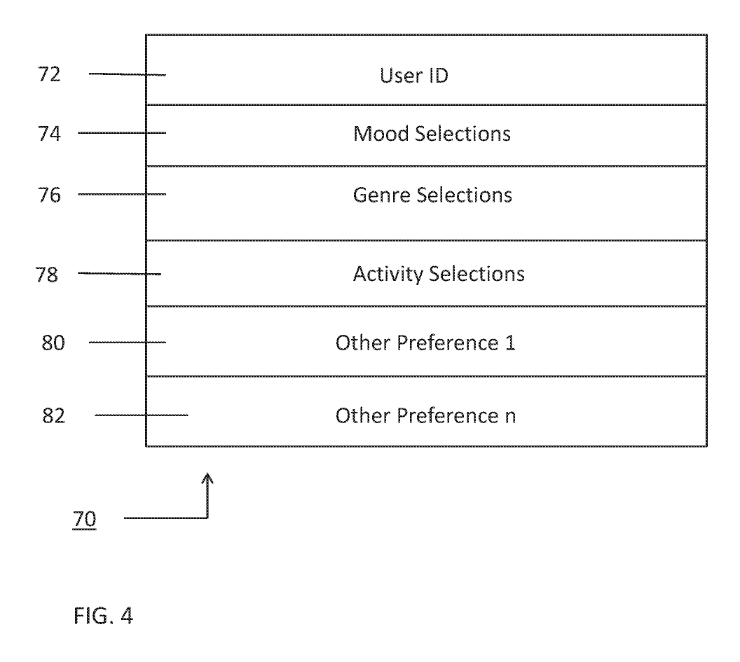

There is shown in FIG. 4 an exemplary user profile 70 which may be used by the system 10. The user profile 70 may include a user ID 72 which may, for example, be a household ID or one of a plurality of users within a household. The user profile 72 may include typical selections for a user relating to mood 74, activities 76, and genre 78. These are exemplary only and may be included to reduce the selections available to a user and which may, for example, be made available to a user via a drop down menu. To the extent a selection is not available via a drop down menu, then an override may be available for a user to type in as a selection. Other preferences may be included in the user profile 70, represented by preference 1 80 to preference n 82. It will be understood that any other preferences which may assist in the recommendation based on mood inputs may be included.

Operational Flow Diagram.

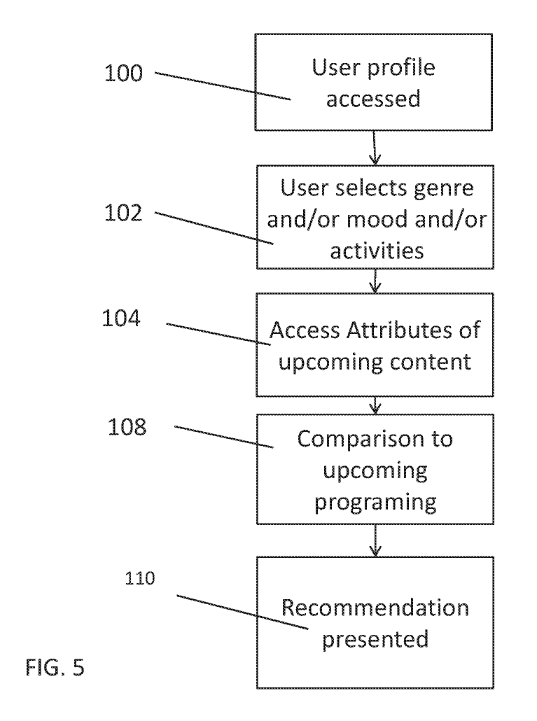

With reference to FIG. 5, there is shown an exemplary process flow diagram of the operation of the present disclosure. The process begins at 100 at which the user profile is accessed. At 102, the user selects one or more of the genre, mood, and/or activities that would be applicable to the current time period. At 104, the attributes of upcoming program are accessed. It will be understood that the attributes may be compiled in advance based on curated information relating to each program or they may be done in real time. At 108, the user information, including the user profile, mood and optionally the genre and/or activity, is compared to the attributes associated with upcoming programming. At 110, the recommendation(s) are presented to the user. It will be understood that further actions may include, for example, a selection by the user based on the recommendation and subsequent streaming of the selected content from the server to the video display 12 through the set top box 14. It will also be understood that the recommendation may include multiple recommendations and that the multiple recommendations may be ordered in accordance with the “best match” or other criteria, including viewing history. As such, the recommendation order may be chosen based on the fact that the user has recently seen the second recommended program and has not seen the first recommended program. The user may nonetheless select the recommendation of his or her own choosing, regardless of the order.

It will be understood that the foregoing use case is exemplary only and that the steps may be performed in any order such that the recommendation that is ultimately presented to the user is based on the user's mood as input to the system.

Although not every conceivable combination of components and methodologies for the purposes describing the present disclosure have been set out above, the examples provided will be sufficient to enable one of ordinary skill in the art to recognize the many combinations and permutations possible in respect of the present disclosure. Accordingly, this disclosure is intended to embrace all such alterations, modifications and variations that fall within the spirit and scope of the appended claims. For example, numerous methodologies for defining triggering events for activation of sensor technologies including onboard video cameras to record risky driving behavior may be encompassed within the concepts of the present disclosure.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

While example embodiments have been described in connection with various computing devices/processors, the underlying concepts can be applied to any computing device, processor, or system capable of inputting data and receiving recommendation of programming events as described herein. The methods and apparatuses or certain aspects or portions thereof, can take the form of program code (i.e., instructions) embodied in tangible storage media having a physical structure, such as floppy diskettes, CD-ROMs, hard drives, or any other machine-readable storage medium having a physical tangible structure (computer-readable storage medium), wherein, when the program code is loaded into and executed by a machine, such as a computer, the machine becomes an apparatus for distributing connectivity and/or transmission time. A computer-readable storage medium, as described herein is an article of manufacture, and thus, is not to be construed as a transitory signal. In the case of program code execution on programmable computers, which may, for example, include server 18, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and systems of the present disclosure may be practiced via communications embodied in the form of program code that is transmitted over some transmission medium, such as over electrical wiring or cabling, through fiber optics, wherein, when the program code is received and loaded into and executed by a machine, such as an EPROM, a gate array, a programmable logic device (PLD), a client computer, a controller, or the like, the machine becomes an apparatus for use in reconfiguration of systems constructed in accordance with the present disclosure. When implemented on a general-purpose processor, the program code combines with the processor to provide a unique apparatus that operates to invoke the functionality described herein.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method comprising:
Suggesting, by a server, one of a plurality of moods of a user based on data from an extrinsic source;
Receiving, by a server, a request for a recommendation for content, wherein said request includes a confirmation of the one of a plurality of moods of the user is indicative of the user's current mood;
responsive to the receiving request, the server retrieving a user profile;
characterizing, by the server, upcoming content by assigning at least one attribute to the content; and
generating, by the server, the recommendation based on the user profile, the user's current mood and the at least one attribute.

2. The method of claim 1 further comprising receiving, by the server, an indication of activity associated with the request and wherein the recommendation is further based on the indication of activity.

3. The method of claim 1 further comprising receiving, by the server, a preference of genre associated with the request and wherein the recommendation is further based on the preference of genre.

4. The method of claim 1 wherein the request applies to a first time period and the recommendation is based on content available during the first time period.

5. The method of claim 4 further comprising receiving a second request wherein the second request applies to a second time period and wherein the generating step comprises generating a first recommendation for the first time period and a second recommendation for the second time period wherein the first recommendation and the second recommendation is based at least in part on the request an indication of the user's mood for the first time period and the second time period.

6. The method of claim 1 wherein the server is in communication with a user device associated with the profile of a user and wherein the request is received from the user device.

7. The method of claim 1 wherein a mood is suggested based on a personal electronic schedule of a user associated with the user profile retrieved by the server.

8. A server comprising:
an input/output system for communicatively coupling the server to a user device a storage source;
a processor communicatively coupled to the input/output system; and
memory storing instructions that cause the processor to effectuate operations, the operations comprising:
receiving, by the server, a request for a recommendation for content;
receiving, by the server, data from an extrinsic source;
suggesting, by the server, a mood for a user based on the data;
responsive to the receiving of the request, the server retrieving a user profile;
characterizing, by the server, upcoming content by assigning at least one attribute to the content; and
generating, by the server, the recommendation based on the user profile, the user's mood and the at least one attribute.

9. The server of claim 8 wherein the operations further include receiving, by the server, an indication of activity associated with the request and wherein the recommendation is further based on the indication of activity.

10. The server of claim 8 wherein the operations further comprise receiving, by the server, a preference of genre associated with the request and wherein the recommendation is further based on the preference of genre.

11. The server of claim 8 the request applies to a first time period and the recommendation is based on content available during the first time period.

12. The server of claim 11 where the operations further comprise receiving a second request wherein the second request applies to a second time period and wherein the generating step comprises generating a first recommendation for the first time period and a second recommendation for the second time period wherein the first recommendation and the second recommendation is based at least in part on the request an indication of the user's mood for the first time period and the second time period.

13. The server of claim 8 wherein the operations further comprise suggesting a mood based on a personal electronic schedule of a user associated with the user profile.

14. A system comprising:
A set top box communicatively coupled to a user device and to a server, the set top box also in communication with an audio-video display and wherein the set top box is configured to receive inputs from the user device and wherein the inputs include an indication of a user's mood.
A server communicatively coupled to set top box, the server having a processor and a memory storing instructions that cause the processor to effectuate operations, the operations comprising:
receiving, by the server, a request from the set top box for a recommendation for content;
receiving, by the server, data from an extrinsic source;
suggesting, by the server, a mood for a user based on the data;
responsive to the receiving of the request, the server retrieving a user profile;
characterizing, by the server, upcoming content by assigning at least one attribute to the content;
generating, by the server, the recommendation based on the user profile, the user's mood and the at least one attribute; and
receiving, by the server, a selection based on the recommendation.

15. The system of claim 14 wherein the operations further comprise streaming content associated with the selection to the set top box for viewing on the audio-video display.
